(19) United States
(12) Patent Application Publication
(10) Pub. No.: US 2021/0282563 A1
(43) Pub. Date: Sep. 16, 2021

(54) SMART SOFA

(71) Applicant: GHL America LLC, Kent, WA (US)

(72) Inventor: Linh Hong Nguyen, Kent, WA (US)

(21) Appl. No.: 16/818,909

(22) Filed: Mar. 13, 2020

(51) Int. Cl. A47C 17/86; A47C 7/74; A47C 7/72; A47C 31/00; A61H 23/02

(52) U.S. Cl. CPC A47C 17/86; A47C 7/748; A47C 7/725; A47C 31/008; A61H 2203/0437; A61H 2201/5097; A61H 2201/0207; A61H 2203/0431; A61H 23/02

(57) ABSTRACT

In embodiments, this disclosure is directed to sofas which may be conventional appearing sofas but that include, for example, a chaise for a sectional set or in the middle of a normal or studio sofa or a chair, that includes heating, massage, vibration, and/or airbag systems. The sofa may thus integrally include a vibration system, a heating system, a massage system, and/or an airbag system. In embodiments, the heating system may be capable of keeping the seat warm to a temperature of approximately 40° C. In other embodiments, the temperature may go as high as 70° C. in a therapeutic system.

### BACKGROUND OF THE DISCLOSURE

### Field of the Invention

This disclosure is generally directed to furniture, and more specifically, sofas that include systems including heating, massage, vibration, and/or airbag systems.

### Description of the Related Art

Conventionally, chairs for massaging, heating, etc., are single, stand-alone unit chairs. Sofas have conventionally not included heating, massage, vibration, and/or airbag systems as a chaise or chair that is a part of a sectional or sofa. A need exists for sofas that include heating, massage, vibration, and/or airbag systems that are integrally included in the sofa and not in separate stand-alone chairs.

### SUMMARY OF THE INVENTION

In embodiments, this disclosure is directed to sofas which may be conventional appearing sofas but that include, for example, a chaise for a sectional set or in the middle of a normal or studio sofa a chair that includes heating, massage, vibration, and/or airbag systems. The sofa may thus integrally include a vibration system, a heating system, a massage system, and/or an airbag system. In embodiments, the heating system may be capable of keeping the seat warm to a temperature of approximately 40° C.

Other features and aspects will be apparent from the following detailed description, the drawings, and the claims.

### BRIEF DESCRIPTION OF THE DRAWINGS

FIG. 1 shows one embodiment of a couch system of the disclosure.

FIG. 2 shows another embodiment of a couch system of the disclosure.

FIG. 3 shows another embodiment of a couch system of the disclosure.

FIG. 4 shows another embodiment of a couch system of the disclosure.

FIG. 5 shows another embodiment of a couch system of the disclosure.

FIG. 6 shows another embodiment of a couch system of the disclosure.

FIG. 7 shows another embodiment of a couch system of the disclosure.

FIG. 8 shows an embodiment of remote control for a couch system of the disclosure.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, products, and/or systems, described herein. However, various changes, modifications, and equivalents of the methods, products, and/or systems described herein will be apparent to an ordinary skilled artisan.

In embodiments, this disclosure is directed to sofas which may be conventional appearing sofas but that include, for example, a chaise for a sectional set or in the middle of a normal or studio sofa or a chair, that includes heating, massage, vibration, and/or airbag systems. The sofa may thus integrally include a vibration system, a heating system, a massage system, and/or an airbag system. In embodiments, the heating system may be capable of keeping the seat warm up to a temperature of approximately 40° C.

In embodiments, the vibration system, heating system, massage system, and\or airbag system may be controlled by remote control with or without a cable.

Heating elements include a heating coil, heat protection fabric, and heat protection felt.

A vibration system includes a turning or vibrating spring that is controlled by a motor that can rotate with various speeds.

The vibration system may be similar to the Cell Baec™ vibration system. A motor is connected to a board; the motor vibrates with various speeds and transfers the vibration to the board and onto the sofa's surface.
Motherboard 6 carries out commands from remote control 8.

Airbags and Airbag Holders may be similar to the system in the AirChiro™ although no heat ceramic may be on top of the air cell/bag.

Mother Board 6 controls the amount of air that is pumped in each Airbag and may create an orchestra system that moves up and down, massaging the body that sits on it.

An Argeta Ceramic™ mat can be put on the surface of the sofa in another embodiment. It helps to emit heat that is generated by a heating element and create/emit infrared heat rays through the surface of the Argeta Ceramic™.

A remote control can control temperatures that can range from approximately 40° to 70° C., control the vibration speed levels from low, mild, or hard and set up timing for a specific number of time, change to a different mode, and turn the system on/off.

In other embodiments, the vibration system, heating system, massage system, and/or the airbag system may be controlled by a mobile device or smart phone app.

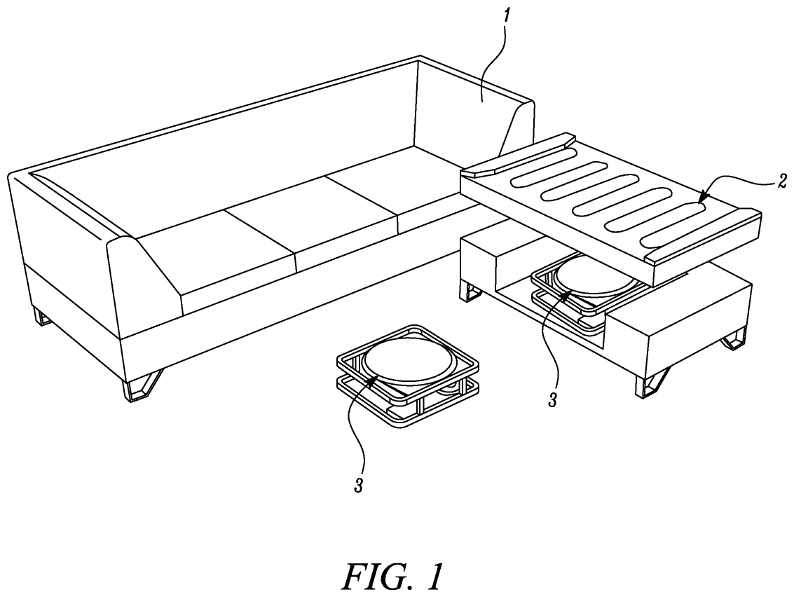

FIG. 1 shows one embodiment of a couch system of the disclosure. FIG. 1 shows couch 1 with heating elements 2, and vibration system 3.

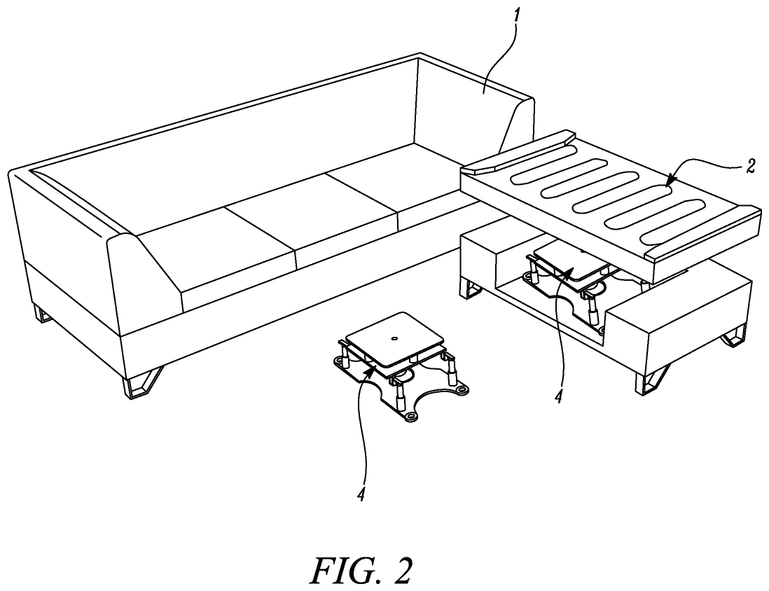

FIG. 2 shows another embodiment of a couch system of the disclosure. FIG. 2 shows couch 1, heating elements 2, and vibration system 4.

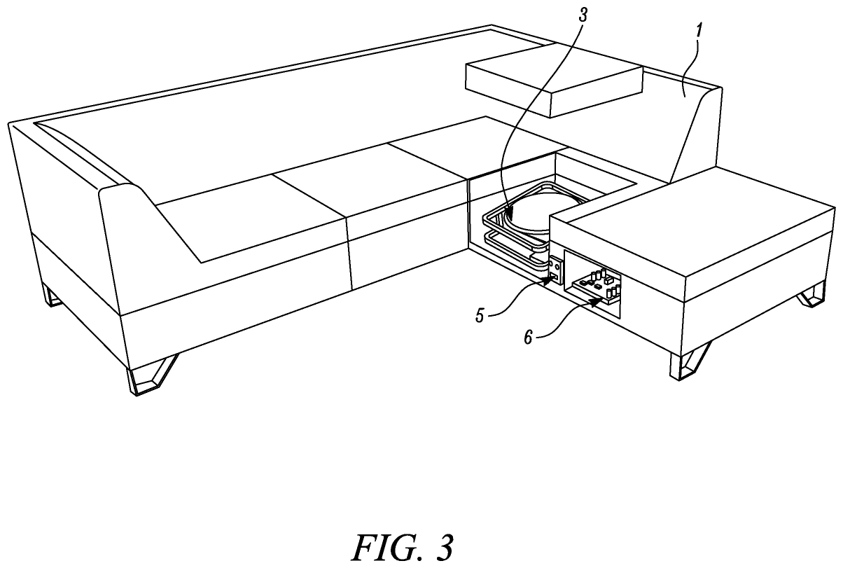

FIG. 3 shows another embodiment of a couch system of the disclosure. FIG. 3 shows couch 1, vibration system 3, power outlet 5, and motherboard 6.

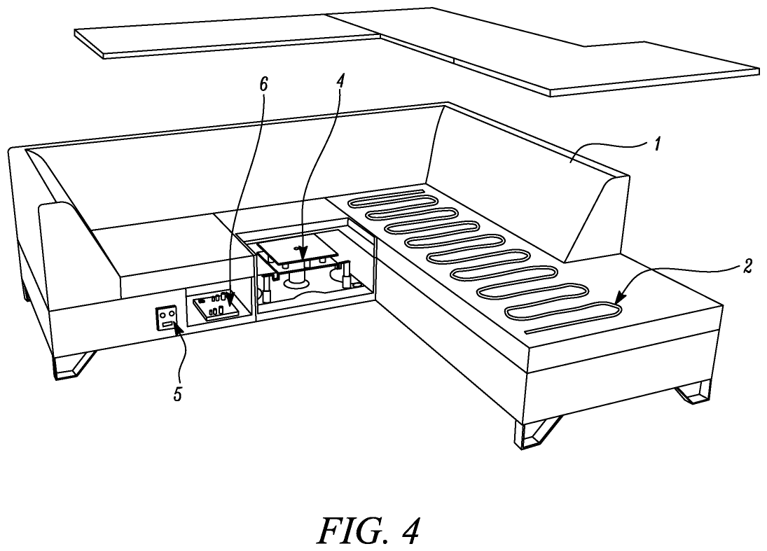

FIG. 4 shows another embodiment of a couch system of the disclosure. FIG. 4 shows couch 1, heating elements 2, vibration system 4, power outlet 5, and motherboard 6.

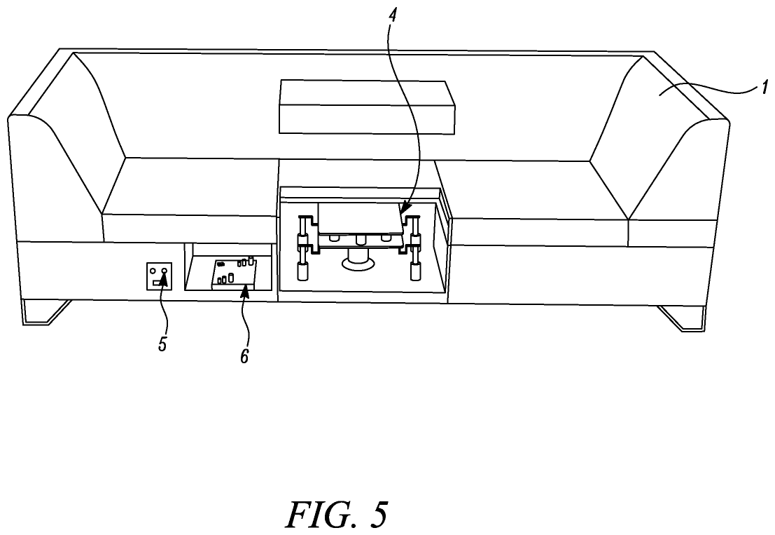

FIG. 5 shows another embodiment of a couch system of the disclosure. FIG. 5 shows couch 1, vibration system 4, power outlet 5, and motherboard 6.

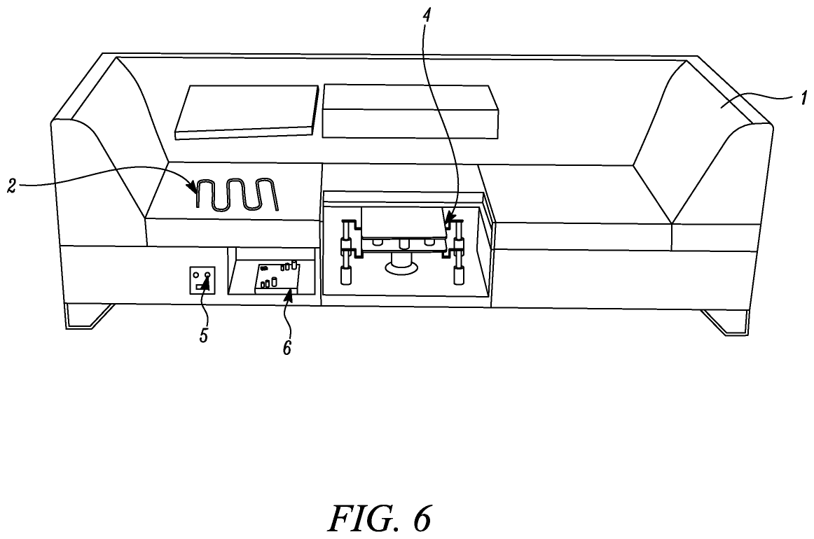

FIG. 6 shows another embodiment of a couch system of the disclosure. FIG. 6 shows couch 1, heating elements 2, vibration system 4, power outlet 5, and motherboard 6.

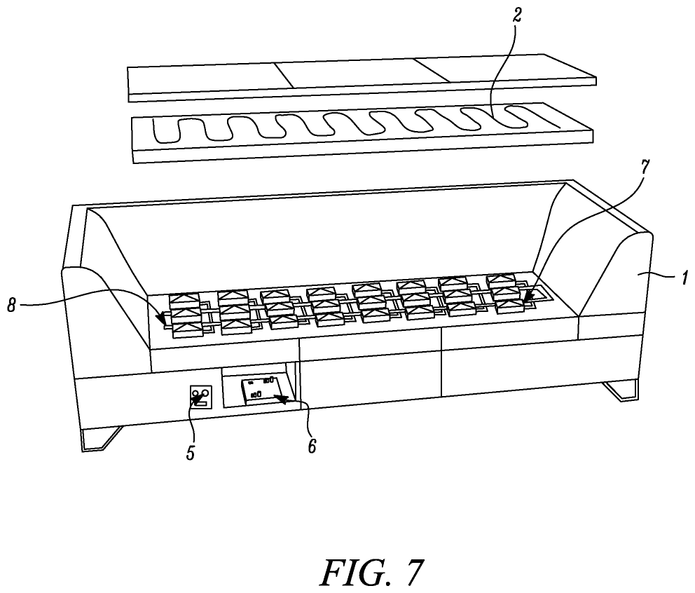

FIG. 7 shows another embodiment of a couch system of the disclosure. FIG. 7 shows couch 1, heating elements 2, power outlet 5, motherboard 6, airbags 7, and airbag holder 8.

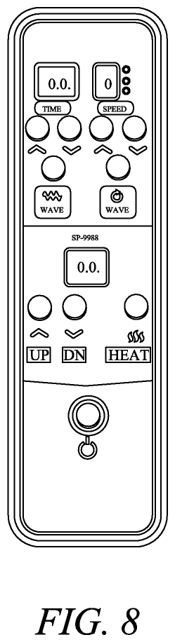

FIG. 8 shows an embodiment of remote control 9 for a couch system of the disclosure.

While this disclosure includes specific examples, it will be apparent after an understanding of the disclosure of this application has been attained that various changes in form and details may be made in these examples without departing from the spirit and scope of the claims and their equivalents.

What is claimed is:

1. A sofa comprising:
a chair or chaise integrally including a massage system, a heating system, a vibration system, and\or an airbag system.

2. The sofa of claim 1, wherein the heating system is included and is capable of heating the chair or chaise to a temperature of approximately 40° C.

3. The sofa of claim 1, wherein the massage system, heating system, vibration system, and/or airbag system, is controlled with a remote control unit.

4. The sofa of claim 3, wherein the remote control unit is a wireless remote control unit.

5. The sofa of claim 1, wherein the massage system, heating system, vibration system, and\or airbag system is controlled with a mobile device or smart phone app.
